(19) United States
(12) Patent Application Publication
(10) Pub. No.: US 2018/0196834 A1
(43) Pub. Date: Jul. 12, 2018

(54) STORING DATA IN A DEDUPLICATION STORE

(71) Applicant: HEWLETT PACKARD ENTERPRISE DEVELOPMENT LP, Houston, TX (US)

(72) Inventors: Siamak Nazari, Fremont, CA (US); Jin Wang, Fremont, CA (US); Srinivasa D. Murthy, Fremont, CA (US)

(21) Appl. No.: 15/741,961

(22) PCT Filed: Jul. 30, 2015
(86) PCT No.: PCT/US2015/042831

§ 371 Date: Jan. 4, 2018

(51) Int. Cl. G06F 17/30; G06F 9/455

(52) U.S. Cl. CPC G06F 17/30303; G06F 2009/45583; G06F 9/45558; G06F 17/3033

(57) ABSTRACT

Techniques are provided for storing data in a deduplication store. A method includes calculating a fingerprint for data stored in a client data store. The fingerprint is compared to each of a plurality of fingerprints in a deduplication store. If the data fingerprint matches one of the plurality of fingerprints in the deduplication store, the data is moved to the deduplication store, and a back reference to the data in the deduplication store is placed in the client data store.

### BACKGROUND

Primary data storage systems provide data services to their clients through the abstraction of data stores, for example, as virtual volumes. These virtual volumes could be of different types, such as fully pre-provisioned or thin-provisioned or thin-provisioned and deduplicated.

### DESCRIPTION OF THE DRAWINGS

Certain exemplary embodiments are described in the following detailed description and in reference to the drawings, in which:

FIG. 1 is an example of a system for storing deduplicated data;

FIG. 2 is a schematic example of a system for storing deduplicated data;

FIG. 3 is a schematic example of a system for storing deduplicated data;

FIG. 4 is a process flow diagram of an example method for storing deduplicated data;

FIG. 5A is a block diagram of an example non-transitory, computer readable medium comprising code to direct one or more processors to save deduplicated data; and

FIG. 5B is a another block diagram of the example non-transitory, computer readable medium comprising code to direct one or more processors to save deduplicated data.

### DETAILED DESCRIPTION

Primary data storage systems provide data services to their clients through the abstraction of data stores, for example, as virtual volumes. These virtual volumes could be of different types, such as fully pre-provisioned or thin-provisioned or thin-provisioned and deduplicated. Such virtual volumes eventually need physical storage to store the data written to the virtual volumes. Normal thin-provisioned volumes can have data stores that are private to each such virtual volume. When a storage service provides deduplication among multiple virtual volumes, there can be a common deduplication store that is shared among such virtual volumes. Often, all data, whether it is duplicate data with multiple references or not, is saved in the common deduplication store. The virtual volumes only save deduplication collision data on local data stores when the data is different from data already residing in the deduplication store but has the same fingerprint signature.

Techniques described herein combine data stores, such as virtual volumes, with a deduplication store to efficiently store data. In examples described herein, the common deduplication store is used only to store duplicate data. When new data gets written to a client data store, such as a data store associated with a virtual volume, for the first time, the data gets stored in the client data store. A link to the data in the data store is written to the deduplication store, wherein the link includes the fingerprint, or hash code, associated with the data and a back reference to the data store holding the data. When a subsequent write to any of the other client data stores occurs, a fingerprint of the new data is computed and compared to the fingerprints in the deduplication store. If the new fingerprint matches a fingerprint previously stored in the deduplication store, the new data is moved to the deduplication store. Back references are then written to the associated client data stores to point to the deduplication store.

In deduplication systems without reference counting, unreferenced pages in the deduplication store are garbage collected periodically. If the deduplication store is used for all data, there can be a lot of data in the deduplication store with only single references. When such singleton data gets overwritten, it will create a lot of unreferenced pages that need to be garbage collected. This demands more aggressive garbage collection, which can adversely impact data services. If garbage collection is not aggressive enough, it may lead to larger deduplication store sizes. Thus, the aggressiveness of the garbage collection is balanced with the size of the storage space. In deduplication systems without reference counts and with background garbage collection, the approach described herein may result in less garbage, e.g., orphaned data occupying system storage space, and fewer singleton references in the deduplication store.

With data stored in the private data stores, data that is overwritten may be done by replacement of the old data with the new data in place. The new data and old data may have different fingerprints, and when the fingerprint of the new data is calculated, the old link in the deduplication store may be replaced. Further, by storing singleton references in private data stores, better performance may be achieved for sequential writes of singleton references, through coalescing writes to backend disks.

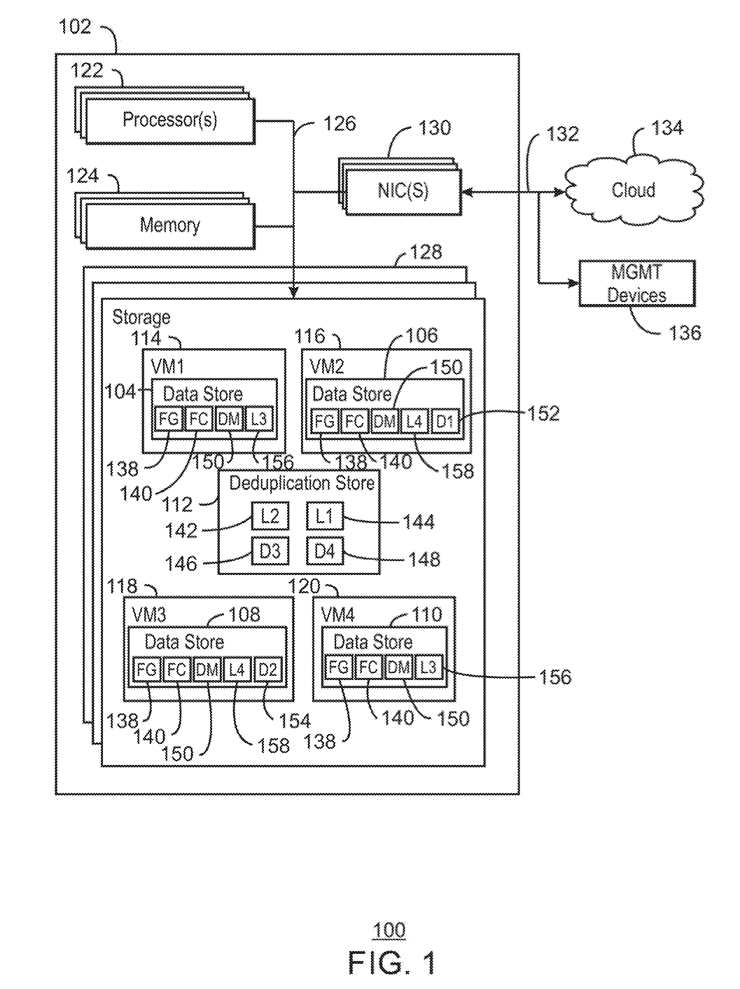

FIG. 1 is an example of a system 100 for storing deduplicated data. In this example, a server 102 may perform the functions described herein. The server 102 may host a number of client data stores 104-110, as well as a deduplication store 112. The client data stores 104-110 may be part of virtual machines 114-120 or may be separate virtual drives, or physical drives, controlled by the server 102.

The server 102 may include a processor (or processors) 122 that is configured to execute stored instructions, as well as a memory device (or memory devices) 124 that stores instructions that are executable by the processor 122. The processor 122 can be a single core processor, a dual-core processor, a multi-core processor, a computing cluster, a cloud sever, or the like. The processor 122 may be coupled to the memory device 124 by a bus 126 where the bus 126 may be a communication system that transfers data between various components of the server 102. In embodiments, the bus 126 may be a PCI, ISA, PCI-Express, or the like.

The memory device 124 can include random access memory (RAM), e.g., static RAM, DRAM, zero capacitor RAM, eDRAM, EDO RAM, DDR RAM, RRAM, PRAM, read only memory (ROM), e.g., Mask ROM, PROM, EPROM, EEPROM, flash memory, or any other suitable memory systems. The memory device 124 may store code and links configured to administer the data stores 104-110.

The server 102 may also include a storage device 128. In some examples, multiple storage devices 128 are used, such as in a storage attached network (SAN). The storage device 128 may include non-volatile storage devices, such as a solid-state drive, a hard drive, an optical drive, a flash drive, an array of drives, or any combinations thereof. In some examples, the storage device 128 may include non-volatile memory, such as non-volatile RAM (NVRAM), battery backed up DRAM, and the like.

A network interface controller (NIC) 130 may also be linked to the processor 122. The NIC 130 may link the server 102 to a network 132, for example, to couple the server to clients located in a computing cloud 134. Further, the network 132 may couple the server 102 to management devices 136 in a data center to set up and control the client data stores 104-110.

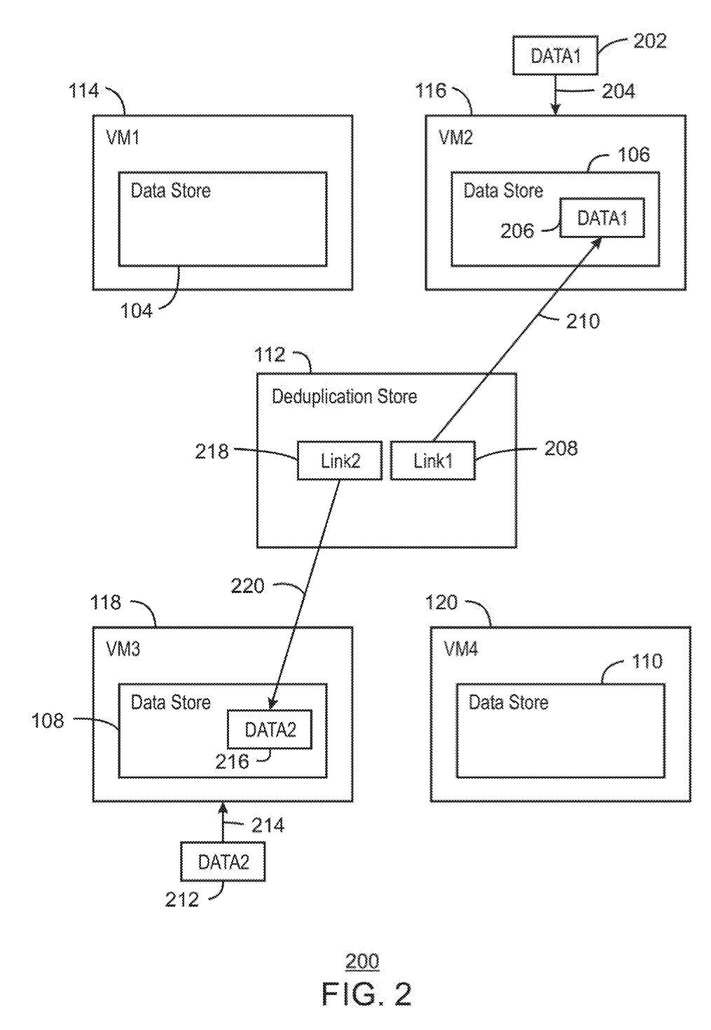

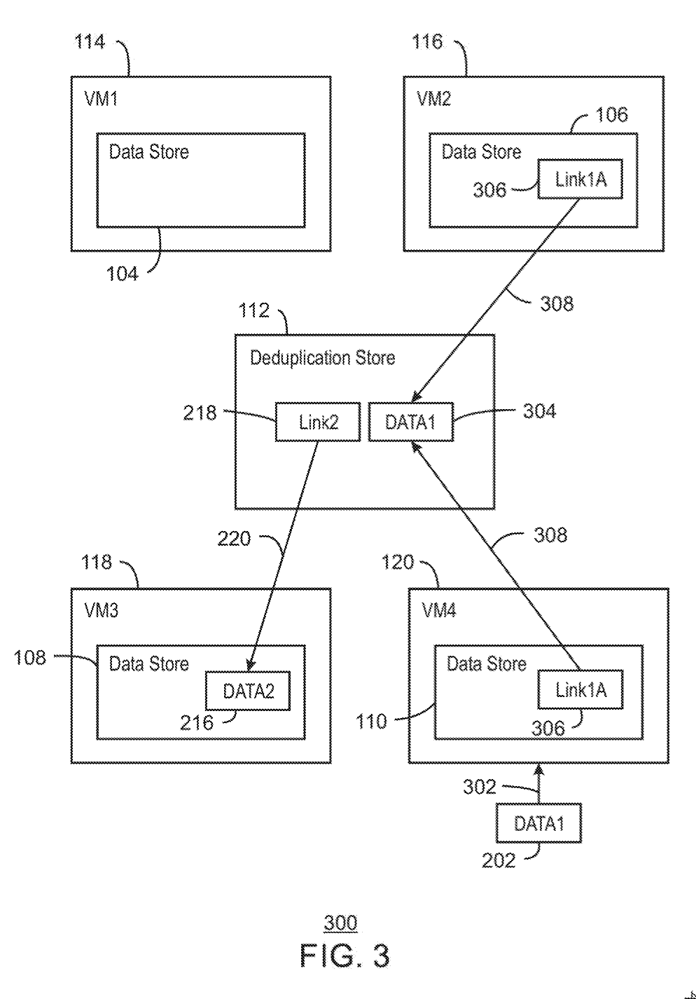

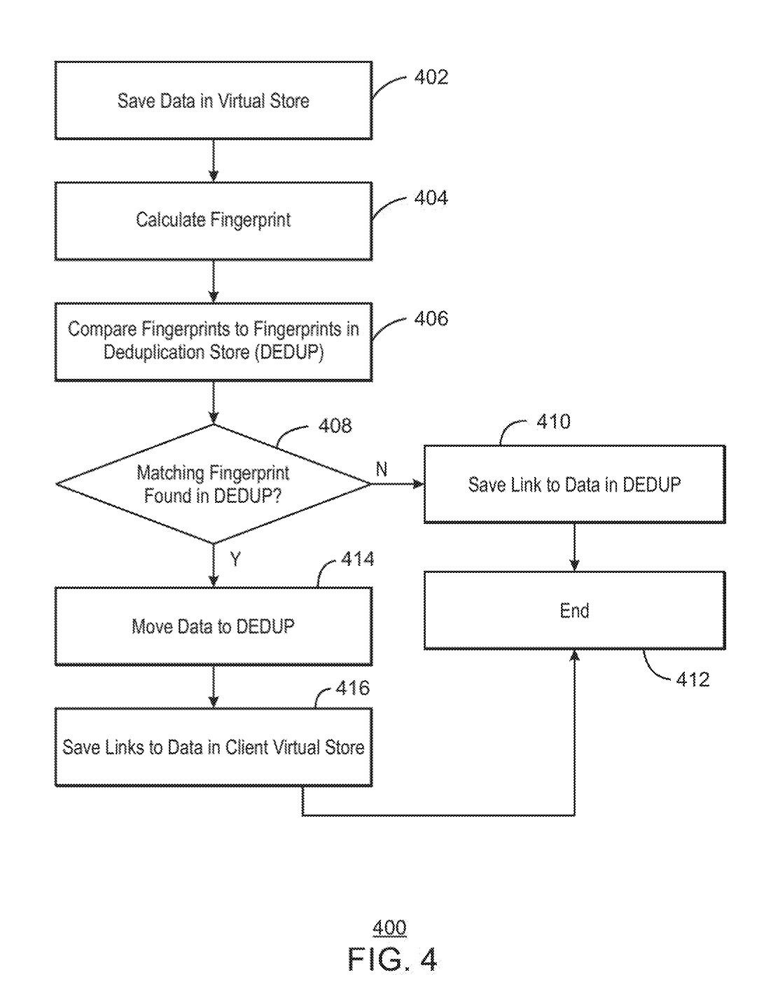

The storage device 128 may include a number of modules configured to provide the server 102 with the deduplication functionality. For example, a fingerprint generator (FG) 138, which may be located in the client data stores 104-110, may be utilized to calculate a fingerprint, e.g., a hash code, for new data written to the client data store. A fingerprint comparator (FC) 140 may be used to compare the fingerprints generated to fingerprints in the deduplication store, e.g., associated with either links 142 and 144 or data 146 and 148. If a fingerprint matches, a data mover (DM) 150 may then be used to move the data to the deduplication store 112, if it is not already present. If the data is already in the deduplication store 112, the DM 150 may be used to copy a back reference to the client data store 104-110 to point to the data in the deduplication store 112 and remove the data from the client data store 104-110. The process is explained further with respect to the schematic drawings of FIGS. 2 and 3 and the method of FIG. 4.

In the present example, a single copy of data D1 152 is saved to client data store 106 in virtual machine 2 116. An associated link L1 144, including a fingerprint of the data D1 152 and a backreference to the data D1 152 in the client data store 106 is in the deduplication store 112. A single copy of a second piece of data D2 154 is saved to client data store 108 in virtual machine 3 118. An associated link L2 142, including a fingerprint of the data D2 154 and a backreference to the data D2 154 in the client data store 108 is in the deduplication store 112.

Further, in this example, data D3 146 is duplicate data that has been written to more than one client data store. A single copy of the data D3 146 is saved to the deduplication store 112 along with the fingerprint of the data. Links L3 156 to this data D3 146, are saved to the associated client data stores 104 and 110. Similarly, data D4 148 is duplicate data, in which a single copy is saved to the deduplication store 112 along with the fingerprint of the data. Links L4 158 to this data D3 148, are in the associated client data stores 106 and 108. It may be noted that this example has been simplified for clarity. In a real system, there may be many thousands of individual data blocks and links.

The block diagram of FIG. 1 is not intended to indicate that the system 100 is arranged as shown in FIG. 1. For example, the virtual machines 114-120 may not be present. The client data stores 104-110 may be virtual drives distributed among drives in a storage attached network, as mentioned above. Further, the various operational modules used to provide the deduplication functionality, such as the FG 138, the FC 140, and the DM 150 may be located in the deduplication store 112, or in another location, such as in a separate area of the storage device 128 itself or in a management device 136. In some examples, the deduplication store 112 may include a link generator to associate a matching fingerprint and a back reference to a location for the data in the deduplication store. Further, the deduplication store 112 may include a link saver to save a link to matched data in the deduplication store to a data store.

The techniques described herein may be clarified by stepping through individual data writes. This is described with respect to FIGS. 2 and 3. Although these examples include virtual machines, it can be understood that the present techniques apply to any deduplicated data stores, including virtual drives or deduplicated physical drives.

FIG. 2 is a schematic example 200 of storing deduplicated data. Like numbered items are as described with respect to FIG. 1. In this example, new data, DATA1 202 is written 204 to virtual machine 2 116. A fingerprint for the stored DATA1 206 is calculated and compared to fingerprints in the deduplication store 112. Since DATA1 206 is new (unmatched) data, a link, Link1 208, is stored to the deduplication store 112. Link1 208 has the calculated fingerprint associated with DATA1 206, and a backreference 210 to the location of DATA1 206 in the client data store 106.

Similarly, more new (unmatched) data, DATA2 212 is written 214 to virtual machine 3 118, and saved to the client data store 108 as DATA2 216. A fingerprint is generated for DATA2 216, but since there are no matching fingerprints in the deduplication store 112, a link, Link2 218 is saved in the deduplication store 112. As for Link1 208, Link2 218 includes the fingerprint of DATA2 216 and a backreference 220 to the location of DATA2 216 in the client data store 108.

FIG. 3 is a schematic example 300 of storing deduplicated data. Like numbered items are as described with respect to FIGS. 1 and 2. This example takes place after the example shown in FIG. 2, when DATA1 202 is written 302 to virtual machine 4 120 and is temporarily saved (not shown). In this example, a fingerprint is generated for DATA1 202, which matches the fingerprint saved in Link1 208 of FIG. 2. Accordingly, the matched data is moved to the deduplication store 112, and saved as DATA1 304. A link to DATA1 304, Link 1A 306 is saved to the client data store 110 for virtual machine 4 120 and to the client data store 106 for virtual machine 2 116. Link 1A may include the fingerprint of DATA1 304 and a backreference 308 to the location of DATA1 304 in the deduplication store 112. The associated fingerprint for DATA1 304 may also be kept in the deduplication store 112 for further comparisons in case the data is written to other virtual machines.

FIG. 4 is a process flow diagram of an example method 400 for storing deduplicated data. The method 400 begins at block 402, with the data being saved to a client data store, for example, in a virtual machine, a virtual drive, or a deduplicated physical drive. At block 404, a fingerprint is calculated for the data, for example, by the generation of a hash code from the data. At block 406, the fingerprint is compared to fingerprints saved in the deduplication store.

If, at block 408, a matching fingerprint is not found in the deduplication store, process flow proceeds to block 410. At block 410, a link to the data in the client data store is saved in the deduplication store. The link includes the fingerprint of the data and a backreference to the location of the data in the client data store. If there is an old link associated with old data, it should be removed after the new link to new data is created in DEDUP. The method 400 then ends at block 412.

If a matching fingerprint is found at block 408, at block 414, the data is moved to the deduplication store. In one example, the data already exists in the deduplication store, in which case, no data is moved. At block 416, links to the data are saved to the associated client data stores. These links may include the fingerprint of the data and a backreference to the data saved in the deduplication store. The original fingerprint of the data may also be retained in the deduplication store for further comparisons.

If the data is removed from all but one client, it may be left in the deduplication store to minimize unnecessary data moves that consume resources. If the data is deleted from that final client, then garbage collection may be used to remove the data from the deduplication store.

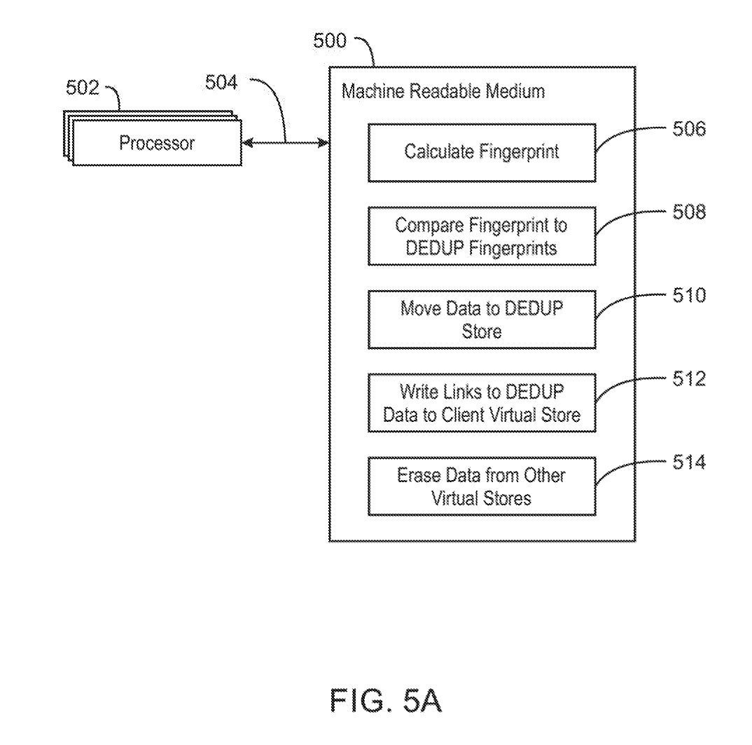

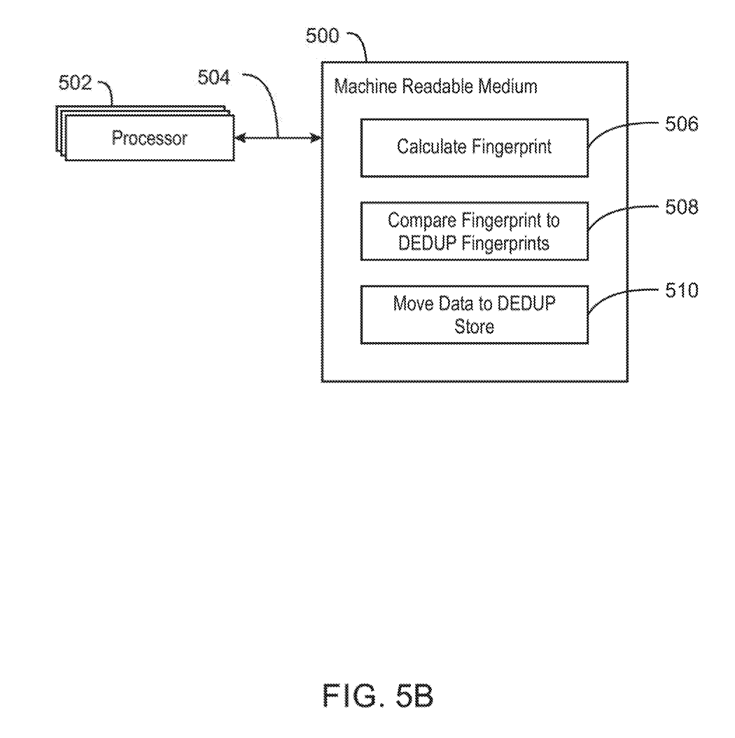

FIG. 5A is a block diagram of an example non-transitory, computer readable medium 500 comprising code or computer readable instructions to direct one or more processors to save deduplicated data. The computer readable medium 500 is coupled to one or more processors 502 over a bus 504. The processors 502 and bus 504 may be as described with respect to the processors 122 and bus 126 of FIG. 1.

The computer readable medium 500 includes a block 506 of code to direct one of the one or more processors 502 to calculate a fingerprint for data written to a client data store. Another block 508 of code directs one of the one or more processors 502 to compare the fingerprint to fingerprints stored in the deduplication store. The computer readable medium 500 also includes a block 510 of code to direct one of the one or more processors 502 to move data to the deduplication store. A block 512 of code may direct one of the one or more processors 502 to write links to the data to each client data store that is associated with that data. Further, a block 514 of code may direct one of the one or more processors 502 to erase the linked data from the client data stores. In one example, the data that is no longer needed in the client data store, e.g., because it is duplicate data saved in the deduplication store, may be marked and removed to free storage space as part of the normal garbage collection functions in the data store.

The code blocks above do not have to be separated as shown, the functions may be recombined into different blocks that perform the functions. Further, the computer readable medium does not have to include all of the blocks shown in FIG. 5A.

FIG. 5B is a another block diagram of the example non-transitory, computer readable medium comprising code to direct one or more processors to save deduplicated data. Like numbered items are as described with respect to FIG. 5A. This simpler arrangement, includes the core code blocks that may be used to perform the functions described herein in some examples.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the scope of the present techniques.

What is claimed is:

1. A method for storing data in a deduplication store, comprising
calculating a fingerprint for data stored in a client data store;
comparing the fingerprint to each of a plurality of fingerprints in the deduplication store; and, if the fingerprint matches one of the plurality of fingerprints in the deduplication store:
moving the data to the deduplication store; and
placing a back reference to the data in the deduplication store in the client data store.

2. The method of claim 1, wherein calculating the fingerprint comprises generating a hash code for the data.

3. The method of claim 1, comprising:
removing the data from a second client data store after saving the data to the deduplication store; and
placing the back reference to the data in the deduplication store to the second client data store.

4. The method of claim 1, comprising associating each of a plurality of client data stores with the deduplication store.

5. The method of claim 1, comprising, if the fingerprint does not match one of the plurality of fingerprints in the deduplication store, saving a link to the data in the deduplication store.

6. The method of claim 5, wherein the link comprises a back reference to the data in the client data store and an associated fingerprint.

7. A system for storing data in a deduplication store, comprising:
a plurality of data stores, each data store comprising:
a deduplication link to matched data in the deduplication store that has a matching fingerprint to data from a second data store; and
unmatched data that does not have a matching fingerprint to data in any other data store;
the deduplication store, comprising:
matched data that is linked to two or more data stores; and
a singleton link to the unmatched data in the data store that does not have a matching fingerprint to data in any other data store.

8. The system of claim 7, the data store comprising a fingerprint generator to calculate a hash code for new data stored in the data store.

9. The system of claim 7, the data store comprising a fingerprint comparator to compare a fingerprint for new data saved in the data store to a fingerprint in the deduplication store.

10. The system of claim 7, the data store comprising a data mover to copy new data that has a matching fingerprint to the data store.

11. The system of claim 7, the deduplication store comprising a link generator to associate the matching fingerprint and a back reference to a location for the data in the deduplication store.

12. The system of claim 7, the deduplication store comprising a link saver to save a link to the matched data in the deduplication store to the second data store.

13. A non-transitory, computer readable medium comprising code for storing data in a deduplication store, the code configured to direct one or more processors to:
calculate a fingerprint for data stored in a client data store;
compare the fingerprint to each of a plurality of fingerprints in a deduplication store; and
moving the data to the deduplication store.

14. The non-transitory, computer readable medium of claim 13, comprising code configured to direct one of the one or more processors to place a back reference to the data in the deduplication store in the client data store.

15. The non-transitory, computer readable medium of claim 13, comprising code configured to direct one of the one or more processors to write a link to the data in the deduplication store to another client data store.
